(19) United States
(12) Patent Application Publication
(10) Pub. No.: US 2014/0057088 A1
(43) Pub. Date: Feb. 27, 2014

(54) Oriented Film Produced In-Process for Use in the Power Stretch Film Market

(71) Applicant: Paragon Films, Inc., Broken Arrow, OK (US)

(72) Inventor: Shaun Eugene Pirtle, Coweta, OK (US)

(21) Appl. No.: 13/920,221

(22) Filed: Jun. 18, 2013

Related U.S. Application Data
(63) Continuation of application No. 12/969,770, filed on Dec. 16, 2010, now abandoned.
(60) Provisional application No. 61/287,760, filed on Dec. 18, 2009.

(51) Int. Cl. B32B 27/08; B29D 7/01

(52) U.S. Cl. CPC B32B 27/08; B29D 7/01
USPC 428/213; 425/224

(57) ABSTRACT

The present disclosure describes compositions, devices, systems, and methods for producing films which simplify the application process by eliminating the need to stretch film before it is wrapped around a load. Such films also provide enhanced load containment and increased resistance to punctures and breaks. In particular, the present disclosure relates to the use of selected resins and an angled die to increase the level of orientation in the film as it is formed.

### FIELD OF THE DISCLOSURE

The present disclosure generally relates to compositions, devices, systems, and methods for producing oriented film in-process for use in the power stretch film market. In particular, the present disclosure relates to the use of selected resins and an angled die to increase the level of orientation in the film as it is formed, thus eliminating the need to stretch the film prior to use.

### BACKGROUND OF THE DISCLOSURE

Stretch films are widely used in a variety of bundling and packaging applications. By and large, power stretch films (i.e., machine films) have become the most common method of securing bulky loads such as boxes, merchandise, produce, equipment, parts, and other similar items on pallets.

Machine films are first stretched and then wound onto the load in a single operation. Stretching is typically performed by winding the film through a series of rollers that rotate at different speeds and elongate the film to a prescribed level. Due to the wide variety of loads secured by machine films, the level of elongation may range from less than 200 percent to more than 350 percent. The elongation process requires the application of a significant amount of force and imparts high levels of stress and orientation to the film. As a result, any defect, abuse, or excessive stretching of the film (relative to the inherent performance properties of the film) typically results in film breakage.

The objective of stretching the film is to deform the film to a point where only a minimal level of elasticity remains. In theory, the stretched film can then be applied to a load using a secondary force (generally known as the “force-to-load”) in order to achieve a prescribed load containment force. The secondary force is supplied to the film via the rotation of the load or the rotation of the film-dispensing unit, depending on the type of equipment used, while drag or braking is applied to the film roll as it is unwound. The level of secondary force available is a function of the inherent properties of the film and the elongation of the film achieved during the stretching process. However, if the overall load containment force is too high, the load may be deformed. Alternatively, if the overall load containment force is too low, the film may relax and fail to contain the load.

The only variables that can be readily modified by an end-user in a machine-film operation are the type of film being used, the percent elongation, and the secondary force. The end-user has limited control over the actual containment force being imparted to the load as that force is primarily a function of the performance properties of the film. For example, referring to FIG. 1, the two films 120, 130 shown on the graph have different inherent performance properties. The y-axis 100 of the graph represents stress, which is the amount of force imparted to stretch or deform the film. The x-axis 110 of the graph represents strain, which is the percent elongation of the film. As can be seen from the graph, the same level of stress applied to two different films 120, 130 may result in different levels of elongation. Similarly, depending on film properties, the same level of elongation may be caused by very different levels of stress. The “x” 140 on FIG. 1 represents the ultimate elongation point, or the point at which the film breaks, which may also vary according to the inherent properties of the film.

Thus, in order to consistently achieve an acceptable level of load containment force, the end-user would have to determine the performance properties of each film being applied. Such properties are influenced by factors such as the type, molecular weight, and density of the resin or resins comprising the film, the number of layers in the film, the relative percentage of each layer and how the layers are combined, the overall gauge of the film, and fabrication variables such as draw down ratio and quench rate. Secondary factors that may affect stretch performance include, but are not limited to, the type and geometry of the load being wrapped, the speed at which the film is unwound and the percent of elongation (i.e., deformation rate), the type of equipment used to wrap the load, the amount of slippage of the film as it is stretched, and any film deformities that could lead to premature failure.

Other products, specifically pre-stretched and machine direction oriented (MDO) films, provide some of the same load containment attributes that conventional machine films demonstrate, but both have performance issues that prevent them from being readily accepted in the automated stretch film industry.

Pre-stretched products are made in an off-line process by taking film from master rolls and cold drawing the film through a series of rollers at high speeds. This stretching process imparts high levels of stress and orientation into the film. Currently available pre-stretched films offer the ability to contain loads with little or no need for additional elongation; however, pre-stretched films lack the resistance to punctures and breakage of conventional machine films.

The MDO process is analogous to pre-stretched films, with the exception that MDO films are stretched prior to the formation of the finished roll of film. Although this type of orientation is sometimes described as “in-process,” this operation is actually a separate and auxiliary function. When compared to conventional machine films, this technique allows for improved control of the final product; however, this process also results in the film being subjected to high levels of orientation and stress. In addition, the production of MDO films requires the purchase and installation of an MDO unit, resulting in significant capital expenditures, increased manufacturing costs, and higher scrap rates.

As can be seen, there is a need for compositions, methods, systems, and devices which can simplify the application process by eliminating the need to stretch film before it is wrapped around a load. There is also a need for compositions, methods, systems, and devices that provide enhanced load containment and resistance to punctures and breaks.

### SUMMARY OF THE DISCLOSURE

The present disclosure provides an oriented film that is produced in-process. The film has a majority component comprised of a linear low density polyethylene (LLDPE) copolymer and a minority component comprised of polyethylenes, polyethylene copolymers, metallocene catalyzed polypropylenes, polypropylenes, polypropylene copolymers, and blends thereof. When compared to machine films, pre-stretched films, and MDO films on a gauge-by-gauge basis, the oriented film has excellent load containment force and resistance to punctures and breaks.

The present disclosure further provides an apparatus for producing oriented film. The apparatus comprises one or more extruders that receive and melt the resins. The apparatus also comprises an angled die that delivers a layer of melted resin from the extruder onto a casting roll to produce a film.

These and other features, aspects, and advantages of the present disclosure will become better understood with reference to the following drawings, description, and claims.

### BRIEF DESCRIPTION OF THE DRAWINGS

The disclosure will be better understood from the following description and the accompanying drawings given as non-limiting examples, and in which:

FIG. 1 illustrates how stress and strain vary according to the inherent performance properties of a film;

FIG. 2 illustrates the means for producing a film from molten resins, according to an embodiment disclosed herein;

FIG. 3 illustrates the standard placement of a cast film die according to the prior art; and

FIG. 4 illustrates the placement of a cast film die at an angle, according to an embodiment disclosed herein.

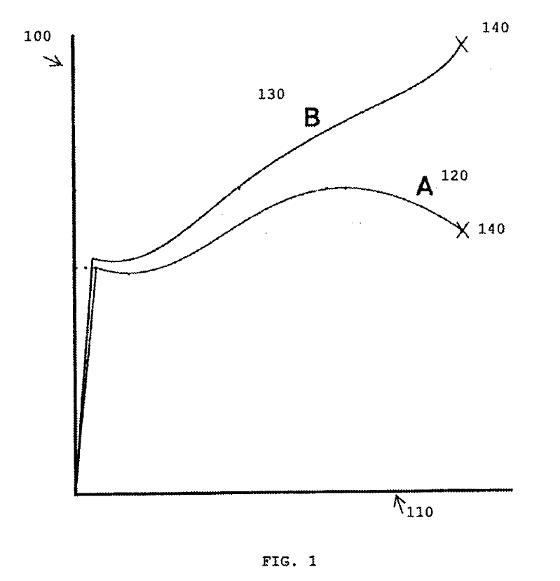

### DETAILED DESCRIPTION

The following detailed description is of the best currently contemplated modes of carrying out the disclosure. The description is not to be taken in a limiting sense, but is made merely for the purpose of illustrating the general principles of the disclosure, since the scope of the present disclosure is best defined by the appended claims.

In-process orientation, or optimizing the orientation of the resin molecules in the machine direction before the film is quenched, may allow many of the inherent properties of the film, such as resistance to punctures and breaks, to be retained while providing enhanced load containment. In-process oriented films provide several advantages over conventional machine films, pre-stretched films, and MDO films. These advantages may include, but are not limited to, (1) requiring less film on a weight-to-weight basis to achieve the same level of load containment force; (2) varying the level of load containment force exerted by approximately the same weight of film; (3) minimizing the reduction in the cross-sectional area of the film as force is applied to the film (i.e., neck-in), thus providing more useable surface area from the same roll width; (4) improving resistance to punctures; (5) reducing liability due to product damage from crushing, deformation, or loss of containment; (6) increasing the load containment force while minimizing the risk of product crushing or deformation; (7) eliminating operational, maintenance, repair, and replacement issues associated with stretching equipment; (8) eliminating improper stretch levels due to problems during the stretching process; (9) reducing the potential for film failure because the film was not sufficiently stretched before it was applied to a load; and (10) reducing the potential for film failure due to breakage caused by edge damage, gels, or other film deformities.

Broadly, the current disclosure includes compositions, systems, devices, and methods for producing oriented film in-process for use in the power stretch film market. More specifically, according to an aspect of the disclosure, the majority of the film may be comprised of higher molecular weight resins than are conventionally used for stretch films. These resins may increase the level of orientation in the film as it is formed. In addition, the resins may be extruded onto the casting roll through an angled die, which may further increase the level of orientation in the film. As a result of the increased level of orientation, the film may be able to contain the load with minimal or no stretching of the film. Thus, the end-user only needs to apply enough force to wrap the film around the load.

The film of the present disclosure may be comprised of one layer or multiple layers, and the composition of each layer may vary. Materials that may be used to produce the film layers may include, but are not limited to, Ziegler Natta (ZN) catalyzed linear low density polyethylene (LLDPE), metallocene catalyzed linear low density polyethylene (m-LLDPE), polyethylenes, polyethylene copolymers, polyethylene terpolymers, polyethylene blends, polypropylenes, metallocene catalyzed polypropylenes, polypropylene copolymers, and blends thereof.

The majority of the film's structure, as measured in percent of the film's total thickness, may consist of a LLDPE copolymer, such as a higher alpha-olefin LLDPE. The melt index of the selected LLDPE may range from 0.5 to 4 (g/10 min. @ 190° C./2.16 kg), with a preferred melt index ranging from 0.6 to 1.2 (g/10 min. @ 190° C./2.16 kg). The density of the LLDPE selected for the majority component may range from 0.900 g/cm³ to 0.960 g/cm³, or from 0.910 g/cm³ to 0.935 g/cm³, with a preferred density of approximately 0.920 g/cm³. Using a LLDPE with a higher molecular weight than is conventionally used in stretch films may increase the level of orientation when the polymer is extruded through a die. The LLDPE may be also combined with other resins, including, but not limited to, other polyethylenes, polyethylene copolymers, polypropylenes, and polypropylene copolymers.

The minority of the film's structure, as measured in percent of the film's total thickness, may be resins comprised of polyethylenes, polyethylene copolymers, metallocene catalyzed polypropylenes, polypropylenes, polypropylene copolymers, or blends thereof. The melt index of the resin or resins selected for the minority component may range from 0.5 to 12 (g/10 min. @ 190° C./2.16 kg), with a preferred melt index ranging from 3 to 5 (g/10 min. @ 190° C./2.16 kg). The density of the resin or resins selected for the minority component may range from 0.850 g/cm³ to 0.960 g/cm³, with a preferred density of approximately 0.917 g/cm³. Depending upon the desired properties of the film, the minority component may consist of one or more layers, and the layers may or may not have the same composition.

The majority component of the film's structure may range from 70 to 92 percent of the film's total thickness. The minority component of the film's structure may range from 8 to 30 percent of the film's total thickness, with a preferred thickness of approximately 16 percent of the film's total thickness. An embodiment of the present disclosure may be a three-layer film, with a middle layer comprising the majority of the film's structure sandwiched between two outer layers comprising the minority of the film's structure. Other embodiments may comprise more than three layers, including but not limited to five, seven, or more layers.

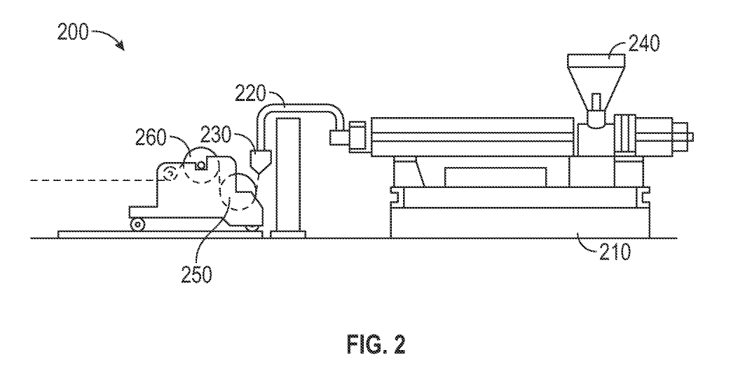

As shown in FIG. 2, a means for producing a film from molten resins 200 may comprise one or more extruders 210 connected by transfer pipes 220 to a die 230. The number of extruders 210 used in the apparatus may depend upon the desired composition of the film. For example, if the film is desired to have a three-layer composition, then three extruders 210 may be used. As another example, if the film has only a single layer, then one extruder 210 may be used.

The extruders 210 may be connected to a source 240 of stock resins. The extruders 210 may heat the stock resins to a molten condition and deliver the molten resins to the die 230 through the transfer pipes 220. The polymers may be extruded through the die 230 onto a casting roll 250. The casting roll 250 may be a 30-inch diameter matt casting roll with a set temperature. As an example, the set temperature of the casting roll 250 may range from 75° F. to 100° F., with a preferred value of approximately 90° F. The film may move from the casting roll 250 to a secondary chill roll 260. The secondary chill roll 260 may be a 20-inch diameter mirror finish secondary chill roll with a set temperature. As an example, the set temperature of the secondary chill roll 260 may range from 65° F. to 90° F., with a preferred value of approximately 85° F.

Oriented film may be produced by a plurality of suitable methods. While the present disclosure specifically relates to chill roll casting techniques, it is to be understood that the present disclosure is not to be limited to that type of film production method. The disclosed compositions, systems, methods, and devices can be successfully employed with other film production methods, including, but not limited to, blown film techniques and tubular bath extrusion.

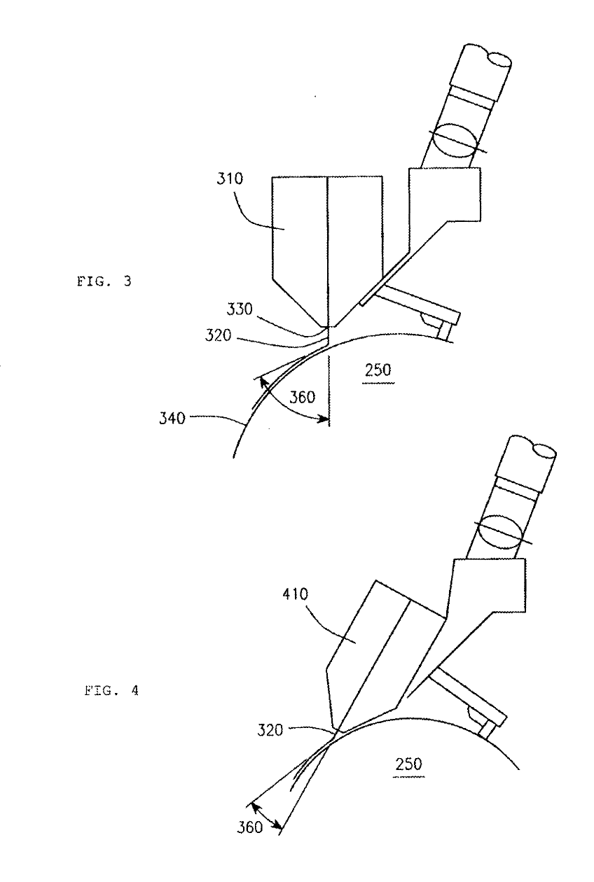

As shown in FIG. 3, dies 310 in the cast stretch film industry are generally positioned vertically. The placement of the die 310 may affect the melt curtain 320, which is defined as the distance between the end 330 of the die 310 through which the polymers are extruded and the surface 340 of the casting roll 250. The placement of the die 310 may also affect the intercept angle 360, which is the angle at which the extruded polymers initially contact the surface 340 of the casting roll 250. For example, the intercept angle 360 for a vertical die 310 may be approximately 90°.

Possible die configurations in the present disclosure may include, but are not limited to, angled, vertical, and horizontal. As shown in FIG. 4, the present disclosure may use an angled die 410. When compared to a vertical die 310, an angled die 410 may reduce the melt curtain 320 and the intercept angle 360. As a result, the molten resins contact the casting roll 250 more quickly, giving the molecules in the resins less time to lose their orientation before they are quenched and frozen in place by the temperature of the casting roll 250 and the secondary chill roll 260. As a result, an angled die 410 may produce thin layers of film with increased machine direction orientation more efficiently than a vertical die 310. Due to the increased machine direction orientation, films produced by the present disclosure do not require stretching in a separate step.

Table 1 presents data comparing selected properties of a conventional machine film and an embodiment of the disclosure:

| | Conventional | |
|---|---|---|
| | Machine Film | Embodiment |
| Thickness (μm) | 20.3 | 7 |
| Width (cm) | 50 | 44.4 |
| Weight of film (g) | 176 | 154 |
| Load containment force (lbs) | 88 | 89 |

The load containment force for the conventional machine film was determined by pre-stretching the film 270 percent and applying five revolutions of film onto the test cube with a force-to-load of approximately 20 pounds. The load containment force for the embodiment was determined with no pre-stretch and a force-to-load of approximately 20 pounds. All other experimental variables were kept constant.

For the conventional machine film, 176 grams of film were required to exert a load containment force of 88 pounds. In contrast, the disclosed embodiment only required 154 grams of film to exert a load containment force of 89 pounds. Thus, using the disclosed embodiment may require less film on a weight-to-weight basis to achieve the same, or improved, level of load containment force. Reducing the amount of film necessary to exert a specific amount of load containment force may conserve material and may reduce processing, shipping, storage, and operational costs without jeopardizing load containment.

Table 2 presents data for an embodiment of the disclosure, comparing the amount of film used to exert low, medium, and high load containment forces:

| | Low | Medium | High |
|---|---|---|---|
| Load containment force (lbs) | 53 | 89 | 117 |
| Weight of film (g) | 160 | 154 | 145 |

The load containment force was determined by applying five revolutions of film onto the test cube with various levels of braking as the film was unwound. All other experimental variables were kept constant.

Because the disclosed embodiment of the film described in Table 2 is already oriented, it has low residual elasticity. As a result, a small increase in the force-to-load may result in a significantly higher load containment force, even though the amount of film applied to wrap the load remains relatively constant. As shown in Table 2, the amount of film applied to wrap the load may even decrease as the load containment force substantially increases. This allows for operational flexibility when wrapping loads without corresponding changes in film usage, making end-users more effective and cost-efficient.

As discussed above, oriented film may be produced by a plurality of suitable methods, including cast or blown film processes. Films produced via the cast film process may be made and processed in the manner previously described. The blown film process may use low blow-up ratios and narrow die gaps to achieve the required orientation. Blown film products may be comprised of single or multiple layers. However, multiple layers may be necessary if high melt index resins are to be used to prevent or minimize melt fracture and interfacial instability. The use of high molecular weight cling agents may also be required to achieve a commercially viable product.

As can be seen, the present disclosure provides compositions, methods, systems, and devices for producing oriented film in-process for use in the power stretch film market. In particular, the present disclosure relates to the use of particular resins and an angled die to increase the level of orientation in the film as it is formed, thus eliminating the need to stretch the film in a separate step, enhancing load containment, and increasing the film's resistance to punctures and breaks.

From the foregoing, it will be understood by persons skilled in the art that compositions, devices, systems, and methods for producing oriented film in-process for use in the power stretch film market have been provided. While the description contains many specifics, these should not be construed as limitations on the scope of the present disclosure, but rather as an exemplification of the preferred embodiments thereof. The foregoing is considered as illustrative only of the principles of the present disclosure. Further, because numerous modifications and changes will readily occur to those skilled in the art, it is not desired to limit the present disclosure to the exact methodology shown and described, and accordingly all suitable modifications and equivalents may be resorted to, falling within the scope of the present disclosure. Although this disclosure has been described in its preferred form with a certain degree of particularity, it is understood that the present disclosure of the preferred form has been made only by way of example and numerous changes in the details of the method may be resorted to without departing from the spirit and scope of the present disclosure.

What is claimed is:

1. An oriented film produced in-process, the oriented film having a majority component and a minority component, as measured in percent of total film thickness, wherein:
the majority component is comprised of a linear low density polyethylene (LLDPE) copolymer; and
the minority component is comprised of resins chosen from the group consisting of polyethylenes, polyethylene copolymers, metallocene catalyzed polypropylenes, polypropylenes, and polypropylene copolymers.

2. The oriented film according to claim 1, wherein the minority component has a thickness ranging from 8 to 30 percent of the total film thickness.

3. The oriented film according to claim 2, wherein the minority component has a thickness of approximately 16 percent of the total film thickness.

4. The oriented film according to claim 1, wherein the resins comprising the minority component have a melt index ranging from 0.5 to 12 (g/10 min. @ 190° C./2.16 kg).

5. The oriented film according to claim 4, wherein the resins comprising the minority component have a melt index ranging from 3 to 5 (g/10 min. @ 190° C./2.16 kg).

6. The oriented film according to claim 1, wherein the resins comprising the minority component have a density ranging from 0.850 g/cm³ to 0.960 g/cm³.

7. The oriented film according to claim 6, wherein the resins comprising the minority component have a density of approximately 0.917 g/cm³.

8. The oriented film according to claim 1, wherein the majority component is comprised of a higher alpha-olefin LLDPE.

9. The oriented film according to claim 1, wherein the LLDPE comprising the majority component has a melt index ranging from 0.5 to 4 (g/10 min. @ 190° C./2.16 kg).

10. The oriented film according to claim 9, wherein the LLDPE comprising the majority component has a melt index ranging from 0.6 to 1.2 (g/10 min. @ 190° C./2.16 kg).

11. The oriented film according to claim 1, wherein the LLDPE comprising the majority component has a density ranging from 0.900 g/cm³ to 0.960 g/cm³.

12. The oriented film according to claim 11, wherein the LLDPE comprising the majority component has a density ranging from 0.910 g/cm³ to 0.935 g/cm³.

13. The oriented film according to claim 11, wherein the LLDPE comprising the majority component has a density of approximately 0.920 g/cm³.

14. An apparatus for producing oriented film, the apparatus comprising:
an extruder that receives a resin and melts the resin to a selected temperature that allows the resin to melt; and
an angled die that delivers a layer of melted resin from the extruder onto a casting roll to produce a film.

15. The apparatus according to claim 14, wherein the die is angled to an intercept angle that is less than 90°.
